(19) United States
(12) Patent Application Publication
(10) Pub. No.: US 2004/0136869 A1
(43) Pub. Date: Jul. 15, 2004

(54) Specimen conveyance holder moving system

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/743,414

(22) Filed: Dec. 23, 2003

(30) Foreign Application Priority Data
Dec. 26, 2002 (JP) 2002-378598

(51) Int. Cl. G01N 35/02

(52) U.S. Cl. 422/65

(57) ABSTRACT

A specimen conveyance holder moving system includes a plurality of belt conveyors which are provided to allow specimen conveyance holders to be conveyed along parallel guide rails, holder moving areas which are provided in respective specific areas of at least two belt conveyors and from which corresponding portions including the guide rails are removed, a holder holding mechanism which is detachably set in the areas and which has guide rail pieces at a lower end, which serve as an alternative to the removed guide rails, a moving mechanism by which the holder holding mechanism is hung and which moves the holder holding mechanism between the belt conveyors and detaches the holder holding mechanism from the areas, and a controller which drives the moving mechanism in association with a conveyance of the specimen conveyance holders.

### CROSS-REFERENCE TO RELATED APPLICATIONS

This application is based upon and claims the benefit of priority from the prior Japanese Patent Application No. 2002-378598, filed Dec. 26, 2002, the entire contents of which are incorporated herein by reference.

### BACKGROUND OF THE INVENTION

1. Field of the Invention

The present invention relates to a specimen conveyance holder moving system for moving a specimen conveyance holder from one belt conveyor to another one.

2. Description of the Related Art

A specimen conveyance holder holds a tube-type specimen container (including a test tube) that contains a specimen such as blood and urine. The specimen conveyance holder can be conveyed by a belt conveyor or the like with the container in an upright position.

There is a so-called columnar rack as the most popular specimen conveyance holder. The columnar rack has a holding section in the center of a columnar base thereof. The holding section vertically holds tube-type specimen containers. The columnar rack has a ring-shaped groove or a ring on its outer surface. The groove or ring is fitted to a guide rail of a belt conveyor. The tube-type specimen containers can thus be conveyed one by one by the belt conveyor.

Using the above columnar rack, the tube-type specimen containers can be conveyed to a given place independently of one another. However, the conveyance of the specimen containers is limited within the range of the same belt conveyor. When a specimen container needs to be conveyed to a place outside the range of the belt conveyor, it has to be moved to another belt conveyor.

Jpn. Pat. Appln. KOKAI Publication No. 2001-124785 discloses a means for moving a specimen container from one belt conveyor to another one as prior art. This prior art means is configured as follows. Only the specimen container is removed from a specimen container holder on one belt conveyor and then moved to that on another belt conveyor using a moving robot arm.

According to the above prior art means, tube-type specimen containers held in one specimen conveyance holder have to be moved one by one to another one. This is very inefficient. When specimen containers are removed from a specimen conveyance holder, only the specimen conveyance holder remains on one belt conveyor, and an empty specimen container holder has to be prepared in advance on another belt conveyor. Consequently, a moving operation including its related operations becomes very complicated.

### BRIEF SUMMARY OF THE INVENTION

An object of the present invention is to provide a specimen conveyance holder moving system having the following advantages.

1) Specimen containers can be moved from one belt conveyor to another with efficiency.

2) The operation for moving the specimen containers is easy to perform.

In order to attain the above object, a specimen conveyance holder moving system according to the present invention has the following characteristic configuration. The other characteristic configurations will be clarified in the Embodiment.

A specimen conveyance holder moving system according to an aspect of the present invention comprises a plurality of belt conveyors which are provided to allow specimen conveyance holders to be conveyed along a pair of parallel guide rails and which have specific areas arranged in parallel to each other; holder moving areas which are provided in respective specific areas of at least two of the belt conveyors and from which corresponding portions including at least the guide rails are removed; a holder holding mechanism which is detachably set in the holder moving areas and which has a pair of parallel guide rail pieces at a lower end, the guide rail pieces serving as an alternative to the removed guide rails; a moving mechanism by which the holder holding mechanism is hung and which moves the holder holding mechanism between the belt conveyors and detaches the holder holding mechanism from the holder moving areas; and a controller which drives the moving mechanism in association with a conveyance of the specimen conveyance holders.

### BRIEF DESCRIPTION OF THE SEVERAL VIEWS OF THE DRAWING

FIG. 1 is a front view showing a configuration of a specimen conveyance holder moving system according to an embodiment of the present invention.

FIG. 2 is a sectional view taken along line 2-2 of FIG. 1.

FIG. 3 is a perspective view showing a configuration of the main part of the specimen conveyance holder moving system according to the embodiment of the present invention.

### DETAILED DESCRIPTION OF THE INVENTION

### EMBODIMENT

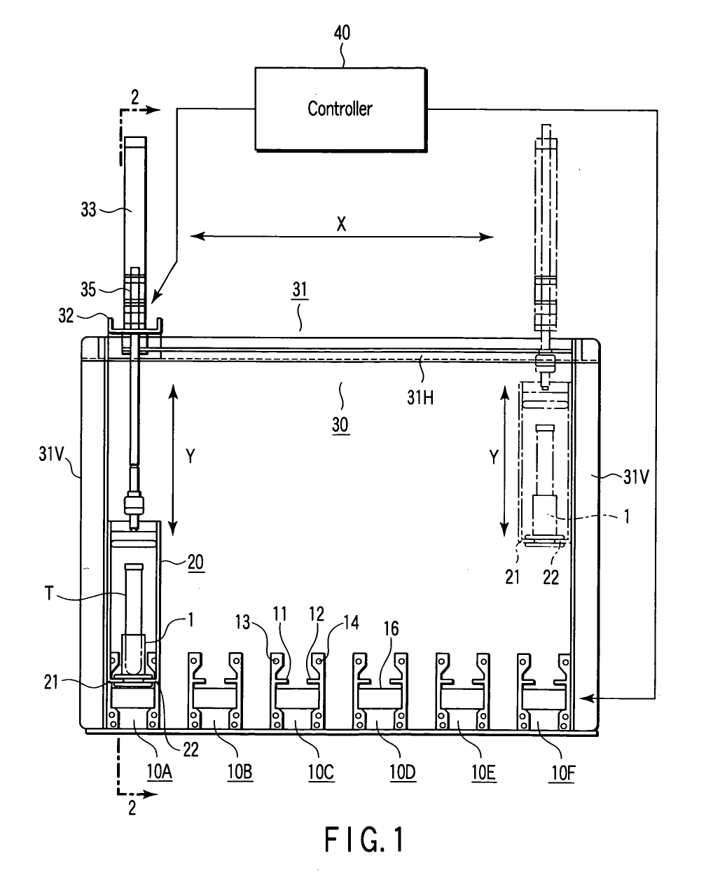

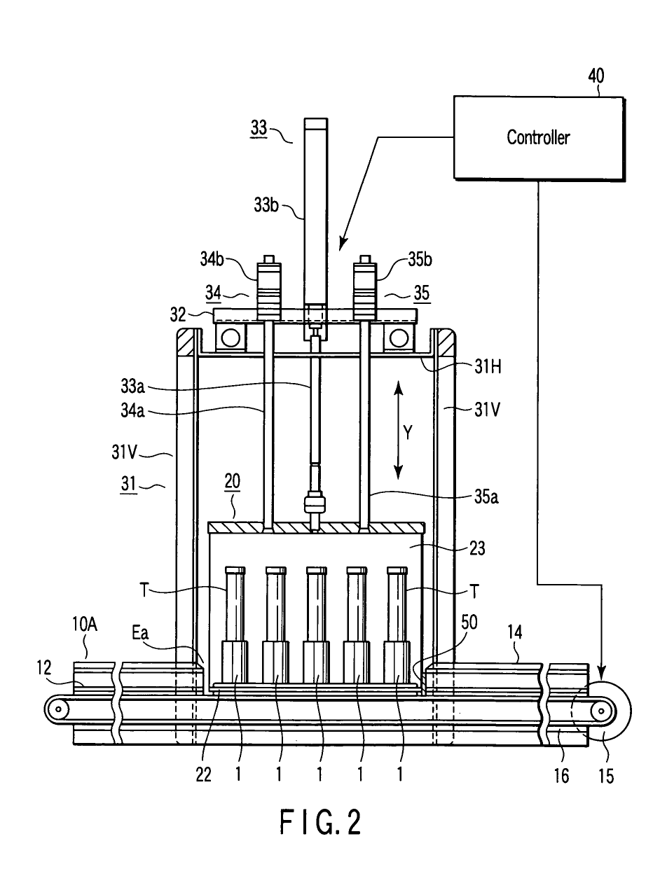

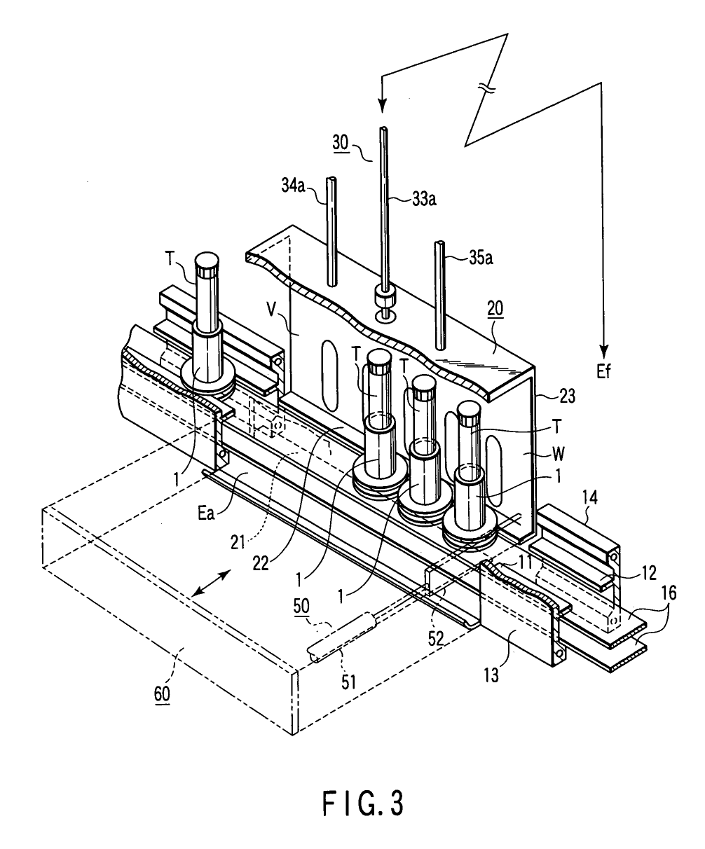

FIGS. 1 to 3 illustrate a specimen conveyance holder moving system according to an embodiment of the present invention. This system comprises a plurality of belt conveyors 10A to 10F having specific areas that are arranged in parallel to each other. The belt conveyors 10A to 10F are provided to allow a specimen conveyance holder 1 called a columnar rack to be conveyed in a given direction. More specifically, each of the belt conveyors 10A to 10F has a pair of supporting frames 13 and 14 on both sides. The supporting frames 13 and 14 have their respective guide rails 11 and 12 that are opposed to each other. A conveying endless belt 16 is formed under the supporting frames 13 and 14 and rotated by a motor 15.

The specimen conveyance holder 1 includes a holding section in the center of a columnar base thereof. The holding section can hold a tube-type specimen container (test tube) T in an upright position. The columnar base has two flanges on its outer surface. The two flanges are arranged at a given interval. A ring-shaped groove is formed between the two flanges. When the specimen conveyance holder 1 is placed on the conveying endless belt 16, the ring-shaped groove is fitted to the guide rails 11 and 12. Thus, the holder 1 can be prevented from toppling due to the vibrations caused by the conveyance.

When the specimen conveyance holder 1 is placed on the endless belt 16 of, e.g., the belt conveyor 10A and the motor 15 is rotated with the ring-shaped groove fitted to the guide rails 11 and 12, the holder 1 is stably conveyed in a given direction as the endless belt 16 rotates.

Of the belt conveyors, at least two belt conveyors 10A and 10F have their respective holder moving areas Ea and Ef (not shown) that correspond to the specific areas formed in parallel to each other. The holder moving areas Ea and Ef are obtained by removing portions of the supporting frames 13 and 14 including the guide rails 11 and 12.

A holder holding mechanism 20 can detachably be set in the holder moving areas Ea and Ef. The holder holding mechanism 20 is formed chiefly of a U-shaped frame 23 that is long in its entirety. A pair of parallel guide rail pieces 21 and 22 is provided at the lower end of the frame 23 to serve as an alternative to the guide rails 11 and 12 whose portions are removed. A holder carry-in port V is formed at one end of each of the guide rail pieces 21 and 22 and a holder carry-out port W is formed at the other end thereof.

The holder holding mechanism 20 is moved by a moving mechanism 30. The holder holding mechanism 20 is hung by the moving mechanism 30. The moving mechanism 30 moves the mechanism 20 between the belt conveyors 10A and 10F and detaches the mechanism 20 from the holder moving areas Ea and Ef.

The moving mechanism 30 includes a supporting mechanism 31 and a moving body 32. The supporting mechanism 31 has a vertical supporting member 31V and a horizontal supporting member 31H that are formed over the belt conveyors 10A to 10F. The moving body 32 can move in the horizontal direction indicated by arrow X along the horizontal supporting member 31H. A lifting mechanism 33 and a pair of guide mechanisms 34 and 35 are attached to the moving body 32. The lifting mechanism 33 includes a hanging rod 33a and a driving source 33b. The bottom end of the hanging rod 33a is coupled to the center of the top end of the frame 23 of the holder holding mechanism 20. The driving source 33b is formed of an air piston/cylinder device that drives the hanging rod 33a up and down as indicated by arrow Y. The guide mechanisms 34 and 35 include guide rods 34a and 35a and holding cylinders 34b and 35b, respectively. The bottom ends of the guide rods 34a and 35a are each coupled to the top end of the frame 23 at a slight distance from the center thereof. The holding cylinders 34b and 35b hold the guide rods 34a and 35a slidably up and down.

A controller 40 is an electronic control circuit including a CPU. The controller 40 drives the moving mechanism 30 in association with the conveyance of the specimen conveyance holder 1.

A shutter 50 includes a driving source 51 that is made of an air piston/cylinder device and a shutter plate 52 that is moved by the driving source 51. When the holder holding mechanism 20 is set in the holder moving area Ea or Ef, the holder carry-out port W is closed to leave a plurality of specimen conveyance holders, which are carried in through the holder carry-in port V, in the holder holding mechanism 20.

An operation of the system so configured will now be described taking as an example the case where the specimen conveyance holder 1 conveyed by the belt conveyor 10A is moved to the belt conveyor 10F.

The moving mechanism 30 starts in response to a control signal from the controller 40. Then, the moving body 32 moves above the belt conveyor 10A and the lifting mechanism 33 lowers. Thus, the holder holding mechanism 20 is set in the holder moving area Ea. Concurrently with this, the shutter 50 operates and the shutter plate 52 closes the carry-out port W of the holder holding mechanism 20 set in the holder moving area.

When a plurality of specimen conveyance holders 1 are conveyed to the holder moving area Ea by the belt conveyor 10A, they are carried into the holder holding mechanism 20 set in the area Ea through the carry-in port V. The ring-shaped groove of each of the specimen conveyance holders 1 is fitted to the guide rail pieces 21 and 22 of the holder holding mechanism 20.

If for example, five specimen conveyance holders 1 are carried into the holder holding mechanism 20, the moving mechanism 30 operates again in response to a control signal from the controller 40. Thus, the lifting mechanism 33 is lifted up first. The holder holding mechanism 20 is lifted up to the upper limit while holding the five specimen conveyance holders 1 by the guide rail pieces 21 and 22. Then, the moving body 32 moves horizontally. The holder holding mechanism 20 moves above the belt conveyor 10F as the moving body 32 moves. The lifting mechanism 33 lowers. Thus, the holder holding mechanism 20 is set in the holder moving area Ef. At this time, the shutter 50 of the belt conveyor 10F is open. Therefore, the five specimen conveyance holders 1 held in the holder holding mechanism 20 are conveyed in a give direction in accordance with the movement of the endless belt 16.

As described above, when the five specimen conveyance holders 1 are carried out of the holder holding mechanism 20, the moving mechanism 30 starts to be reset in response to a control signal from the controller 40. Consequently, the holder holding mechanism 20 performs a process opposite to the above movement and is set again in the holder moving area Ea of the belt conveyor 10A. Then, the mechanism 20 stands by for the next moving operation. Upon completing all the moving operations, the holder holding mechanism 20 return to the initial state.

### Features of the Embodiment

[1] A specimen conveyance holder moving system according to an embodiment of the present invention comprises:

a plurality of belt conveyors 10A to 10F which are provided to allow specimen conveyance holders 1 to be conveyed along a pair of parallel guide rails 11 and 12 and which have specific areas arranged in parallel to each other;

holder moving areas Ea and Ef (not shown) which are provided in respective specific areas of at least two belt conveyors 10A and 10F of the belt conveyors 10A to 10F and from which corresponding portions including at least the guide rails 11 and 12 are removed;

a holder holding mechanism 20 which is detachably set in the holder moving areas Ea and Ef and which has a pair of parallel guide rail pieces 21 and 22 at a lower end, the guide rail pieces 21 and 22 serving as an alternative to the removed guide rails 11 and 12;

a moving mechanism 30 by which the holder holding mechanism 20 is hung and which moves the holder holding mechanism 20 between the belt conveyors 10A and 10F and detaches the holder holding mechanism 20 from the holder moving areas Ea and Ef; and

a controller 40 which drives the moving mechanism 30 in association with a conveyance of the specimen conveyance holders.

In the specimen conveyance holder moving system described above, when it is necessary to change the destination of specimen containers T or make a detour thereof, a plurality of specimen container holders 1 containing and holding the specimen containers T can be moved one by one from one belt conveyor to another. The specimen containers T can thus be moved with very efficiency. Since, moreover, any operation for preparing empty specimen container holders need not be performed at all, the moving operation is very simple to perform.

[2] A specimen conveyance holder moving system according to an embodiment of the present invention comprises:

a plurality of belt conveyors 10A to 10F which are provided to allow specimen conveyance holders 1 to be conveyed along a pair of parallel guide rails 11 and 12 and which have specific areas arranged in parallel to each other;

holder moving areas Ea and Ef (not shown) which are provided in respective specific areas of at least two belt conveyors 10A and 10F of the belt conveyors 10A to 10F such that corresponding portions 60 including at least the guide rails 11 and 12 escape from a conveyance path of each of the belt conveyors 10A to 10F when the specimen conveyance holders are moved;

a holder holding mechanism 20 which is detachably set in the holder moving areas Ea and Ef and which has a pair of parallel guide rail pieces 21 and 22 at a lower end, the guide rail pieces 21 and 22 serving as an alternative to the removed guide rails 11 and 12;

a moving mechanism 30 by which the holder holding mechanism 20 is hung and which moves the holder holding mechanism 20 between the belt conveyors 10A and 10F and detaches the holder holding mechanism 20 from the holder moving areas Ea and Ef; and

a controller 40 which drives the moving mechanism 30 in association with a conveyance of the specimen conveyance holders.

The specimen conveyance holder moving system described above produces the same advantages as those of the system in above item [1]. In addition to this, when no moving operation is performed, the holder moving areas are recovered as a normal conveyance path. Therefore, there is no fear of causing any trouble to the normal conveyance operation of the specimen conveyance holders.

[3] The specimen conveyance holder moving system according to one of above items ([1] and [2], further comprises a shutter 50 which closes a carry-out port W of the holder holding mechanism 20 such that the specimen conveyance holders 1 carried into the holder holding mechanism 20 remain in the holder holding mechanism 20 when the holder holding mechanism 20 is set in the holder moving area Ea or Ef.

In the specimen conveyance holder moving system described above, the specimen conveyance holders 1 reliably remain in the holder holding mechanism 20 and can stably be moved.

### Modification

The specimen conveyance holder moving system according to the embodiment of the present invention can be modified as follows.

The shutter 50 can be attached to the holder holding mechanism 20.

What is claimed is:

1. A specimen conveyance holder moving system comprising:
a plurality of belt conveyors which are provided to allow specimen conveyance holders to be conveyed along a pair of parallel guide rails and which have specific areas arranged in parallel to each other;
holder moving areas which are provided in respective specific areas of at least two of the belt conveyors and from which corresponding portions including at least the guide rails are removed;
a holder holding mechanism which is detachably set in the holder moving areas and which has a pair of parallel guide rail pieces at a lower end, the guide rail pieces serving as an alternative to the removed guide rails;
a moving mechanism by which the holder holding mechanism is hung and which moves the holder holding mechanism between the belt conveyors and detaches the holder holding mechanism from the holder moving areas; and
a controller which drives the moving mechanism in association with a conveyance of the specimen conveyance holders.

2. A specimen conveyance holder moving system comprising:
a plurality of belt conveyors which are provided to allow specimen conveyance holders to be conveyed along a pair of parallel guide rails and which have specific areas arranged in parallel to each other;
holder moving areas which are provided in respective specific areas of at least two of the belt conveyors such that corresponding portions including at least the guide rails escape from a conveyance path of each of the belt conveyors when the specimen conveyance holders are moved;
a holder holding mechanism which is detachably set in the holder moving areas and which has a pair of parallel guide rail pieces at a lower end, the guide rail pieces serving as an alternative to the removed guide rails;
a moving mechanism by which the holder holding mechanism is hung and which moves the holder holding mechanism between the belt conveyors and detaches the holder holding mechanism from the holder moving areas; and
a controller which drives the moving mechanism in association with a conveyance of the specimen conveyance holders.

3. The specimen conveyance holder moving system according to claim 1, further comprising a shutter which closes a carry-out port of the holder holding mechanism such that the specimen conveyance holders carried into the holder holding mechanism remain in the holder holding mechanism when the holder holding mechanism is set in the holder moving area.

4. The specimen conveyance holder moving system according to claim 2, further comprising a shutter which closes a carry-out port of the holder holding mechanism such that the specimen conveyance holders carried into the holder holding mechanism remain in the holder holding mechanism when the holder holding mechanism is set in the holder moving area.
